(19) United States
(12) Patent Application Publication
(10) Pub. No.: US 2008/0180965 A1
(43) Pub. Date: Jul. 31, 2008

(54) Vehicular Lamp

(75) Inventors: Hiromi Nakamura, Shizuoka-shi (JP); Yuichi Shibata, Shizuoka-shi (JP); Yoshinao Daicho, Shizuoka-shi (JP); Nobutaka Tezuka, Shizuoka-shi (JP); Motohiro Komatsu, Shizuoka-shi (JP)

Correspondence Address: Koda/Androlia;Quinn Emanuel Urquhart Oliver & Hedges, LLP, 10th Floor, 865 S. Figueroa Street, Los Angeles, CA, 90017, US

(73) Assignee: Koito Manufacturing Co., Ltd.

(21) Appl. No.: 12/011,864

(22) Filed: Jan. 30, 2008

(30) Foreign Application Priority Data
Jan. 31, 2007 (JP) 2007-020300

(51) Int. Cl. B60Q 1/04

(52) U.S. Cl. 362/507

(57) ABSTRACT

A vehicular lamp having a light source unit 30 provided inside a lamp chamber formed by a lamp body 10 and a front cover 20, wherein a millimeter wave radar 40 is provided inside the lamp chamber, and a light guide plate 60 is provided between the front cover 20 and the millimeter wave radar 40, and the light guide plate 60 is illuminated by the light source of the lamp or by a dedicated light source provided solely for the light guide plate 60.

### BACKGROUND OF THE INVENTION

1. Field of the Invention

The present invention relates to a vehicular lamp having therein a millimeter wave radar.

2. Description of the Related Art

Vehicles with a laser radar used for, for instance, vehicle tracking purposes have come into a practical use. In view of its function, the laser radar must be provided at the front of the vehicle; and in a vehicular lamp disclosed in U.S. Pat. No. 6,459,476 B2, a laser radar is provided inside the lamp unit of the headlamp.

Since the laser light can attenuate easily, shielding should not be provided in front of the laser radar. However, when the space in front of the lamp unit of the headlamp is given to a laser radar, the light emission area of the lamp unit is occupied by the laser radar, causing the problems of a conspicuous non-light emission area and a deteriorated function as a lamp unit due to the reduced light emission surface area. Such a structure is also not preferable in terms of design of vehicular lamps.

### BRIEF SUMMARY OF THE INVENTION

The present invention is to provide a vehicular lamp in which a main light source is installed in a lamp chamber that is formed by a lamp body and a front cover, and this vehicular lamp is characterized in that a millimeter wave radar is provided inside the lamp chamber, and a light guide member is provided between the front cover and the millimeter wave radar so that the light guide member is illuminated.

According to this structure of the present invention, the lamp has a natural outer appearance that shields the millimeter wave radar so as not to be visible from the front of the lamp while minimizing the attenuation of millimeter wave signals and that prevents the reduction of light emission area due to the size of the millimeter wave radar. This is achieved by way of covering the front of the millimeter wave radar with a light guide member that is made of resin or glass which is transparent to visible light. In addition, illumination of the light guide member makes the location where the millimeter wave radar is installed appear as a main light source.

In the present invention, the light guide member is preferably illuminated by the light radiated from the main light source of the lamp. As a result, the overall lamp structure can be simple. Furthermore, in the present invention, the light guide member can be illuminated by light that is radiated from a dedicated light source which is provided solely to be used for the light guide member and is provided inside the lamp chamber separated from the main light source of the lamp. With this structure, the light guide member is illuminated regardless of the lamp main light source and can be used as, for example, a daytime running lamp.

In the present invention, it is preferable that the light guide member be integrally fixed to a front portion of the millimeter wave radar. In this structure, the millimeter wave radar and the light guide member forms a single unit, or the millimeter wave radar, the light guide member and the dedicated light source can be formed into a single unit; and as a result, the assembly workability of the lamp improves.

In addition, in the present invention, the main light source is preferably one that uses a semiconductor light-emitting element and is integrally fixed to the millimeter wave radar. In this structure, since the millimeter wave radar and the dedicated light source are formed as a single unit, the lamp can be more compact.

### BRIEF DESCRIPTION OF THE SEVERAL VIEWS OF THE DRAWINGS

FIG. 1 is a vertical cross-sectional view of the structure of a vehicular lamp according to a first embodiment of the present invention;

FIG. 2 is a vertical cross-sectional view of the structure of a vehicular lamp according to a second embodiment of the present invention;

FIG. 3 is a vertical cross-sectional view of the structure of a vehicular lamp according to a third embodiment of the present invention;

FIG. 4 shows a detailed layout of a light guide plate, a millimeter wave radar, and a dedicated light source in the structure of the third embodiment;

FIG. 5 is a vertical cross-sectional view of the structure of a vehicular lamp according to a fourth embodiment of the present invention;

FIG. 6 is a vertical cross-sectional view of the structure of a vehicular lamp according to a fifth embodiment of the present invention;

FIG. 7 is a vertical cross-sectional view of the structure of a vehicular lamp according to a sixth embodiment of the present invention;

FIG. 8 is a vertical cross-sectional view of the structure of a vehicular lamp according to a seventh embodiment of the present invention; and

FIG. 9 is a vertical cross-sectional view of the structure of a vehicular lamp according to an eighth embodiment of the present invention.

### DETAILED DESCRIPTION OF THE INVENTION

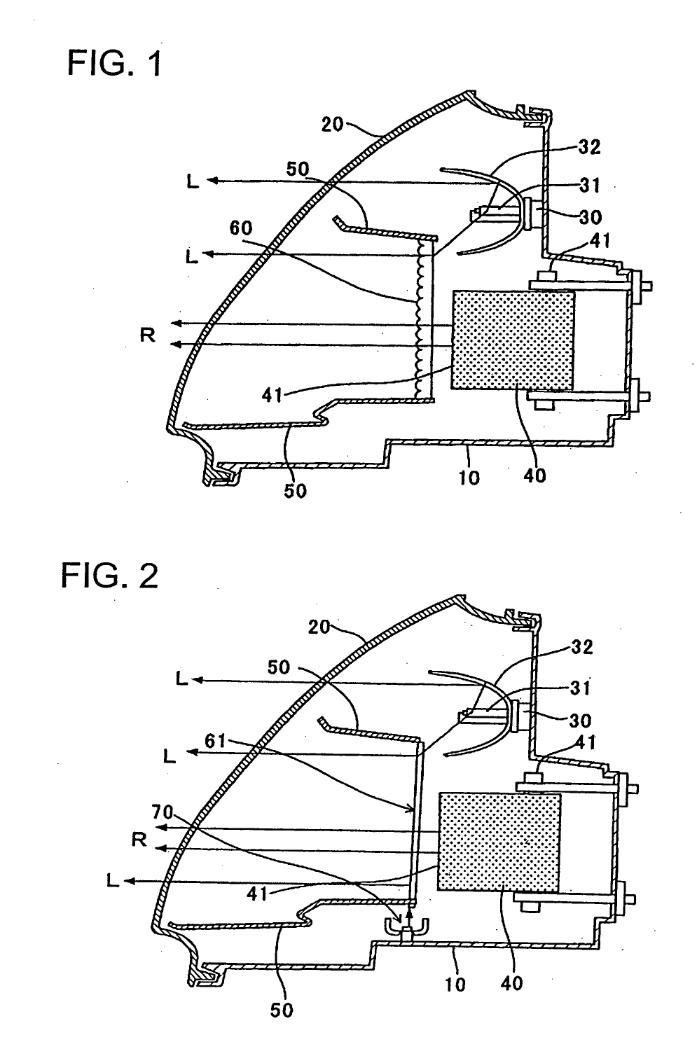

FIG. 1 is a vertical cross-sectional view of the structure of a vehicular lamp according to a first embodiment of the present invention. The vehicular lamp is comprised of a lamp body 10, a front cover 20, a light source unit (main light source) 30, a millimeter wave radar 40, an extension reflector 50, and a light guide plate 60.

The lamp body 10 has, at its front end, the front cover 20 that is made of resin or glass, thus forming a housing, and it accommodates therein the light source unit 30 and the millimeter wave radar 40. The light source unit 30 is comprised of a light source for, for example, a low beam or a high beam and is used to radiate a radiated light L toward the front of the lamp, and the light source unit 30 is structured by a light source bulb 31 and a reflector 32. The reflector 32 is molded so as to effectively reflect the light emitted from the light source bulb 31 forward. The light source unit 30 is properly supported by the lamp body 10.

The millimeter wave radar 40 is installed inside the lamp body 10, and it is a radar that sends and receives a millimeter wave signal R and is used, for instance, for measuring a distance between a host vehicle and a preceding vehicle to give a warning and/or for tracking the preceding vehicle. The millimeter wave radar 40 is tiltably supported in the lamp body 10 by a holder 41 and transmits millimeter wave signal R in an adjustable manner in a sending direction, i.e., in a generally horizontal direction, toward the front (or the light guide plate 60) side from the sending surface 41 which is located on the front surface of the millimeter wave radar 40. The extension reflector 50 is provided in the lamp body 10 so as to effectively reflect the light emitted from the light source unit 30, and at the same time, and it plays a role of supporting the light guide plate 60. The light guide plate 60 is a flat plate formed by a light guide member made of light-transmissive material such as a resin, glass, etc., and it allows light emitted from the light source unit 30 and the millimeter wave signal R sent out from the millimeter wave radar 40 to pass through.

In the vehicular lamp structured as describe above, a portion of the light emitted from the light source unit 30 toward the front of the lamp passes through the light guide plate 60 and advances forward. At that time, the entire light guide plate 60 formed by the light guide member is illuminated; and therefore, the millimeter wave radar 40 is not visible from the front of the lamp. As described above, since a portion of light emitted from the light source unit 30 passes through the light guide plate 60 and advances forward, it is possible to secure a light emission area on the lamp front surface and also possible for the light guide plate 60 to appear as a lamp light source. Furthermore, because the front area of the millimeter wave radar 40 is wide open and the millimeter wave signal R generally passes through resins and glasses, the millimeter wave signal R can be sent forward without any significant attenuation.

In the vehicular lamp 1 according to the first embodiment above, as FIG. 1 shows, the surface of the light guide plate 60 facing the front side of the lamp is formed with a fish-eye lens stepped configuration. Therefore, the millimeter wave radar 40 inside the lamp is not visible from the front of the lamp even when the light source unit 30 is not lit. The first embodiment describes an example in which the light guide plate 60 has a fish-eye lens stepped configuration, but this configuration is not particularly required. In other words, embossing so that the millimeter wave radar 40 is not visible and instead appears as a lamp light source when viewed from the front of the lamp while the light source unit 30 is not lit, or a lens with a stepped configuration that controls the radiating direction of light from the light source bulb 31, can be employed as well.

FIG. 2 is a vertical cross-sectional view of the structure of a vehicular lamp according to the second embodiment of the present invention.

The second embodiment differs from the first embodiment in that it has a light guide plate 61 which is flat and whose front surface is not processed for, for example, stepped configuration. Furthermore, in the second embodiment, a dedicated light source 70 is provided for illuminating the light guide plate 61 which is formed by a light guide member. The dedicated light source 70 is structured from a semiconductor light-emitting element such as an LED (light emitting diode). The dedicated light source can be operated by a dedicated switch provided therefor or can be lit in association with the operation of a small lamp switch for the vehicle. In addition, the dedicated light source can be designed so that it lights during the operation of the radar; and with this structure, the operation of the radar can be confirmed when the dedicated light source is lit.

According to the vehicular lamp of the structure above, the light guide plate 61 is illuminated by the light, which is radiated by the dedicated light source 70 to the side surface of the light guide plate 61 regardless of whether the light source unit 30 is lit or not. Therefore, when the light guide plate 61 is thus illuminated, the millimeter wave radar 40 is not visible from the front of the lamp. Naturally, a portion of the light emitted from the light source unit 30 toward the front of the lamp passes through the light guide plate 61 and advances forward; accordingly, it is possible to secure a light emission area on the lamp front surface. Furthermore, because the space in front of the millimeter wave radar 40 is wide open, the millimeter wave signal R is transmitted forward without any significant attenuation.

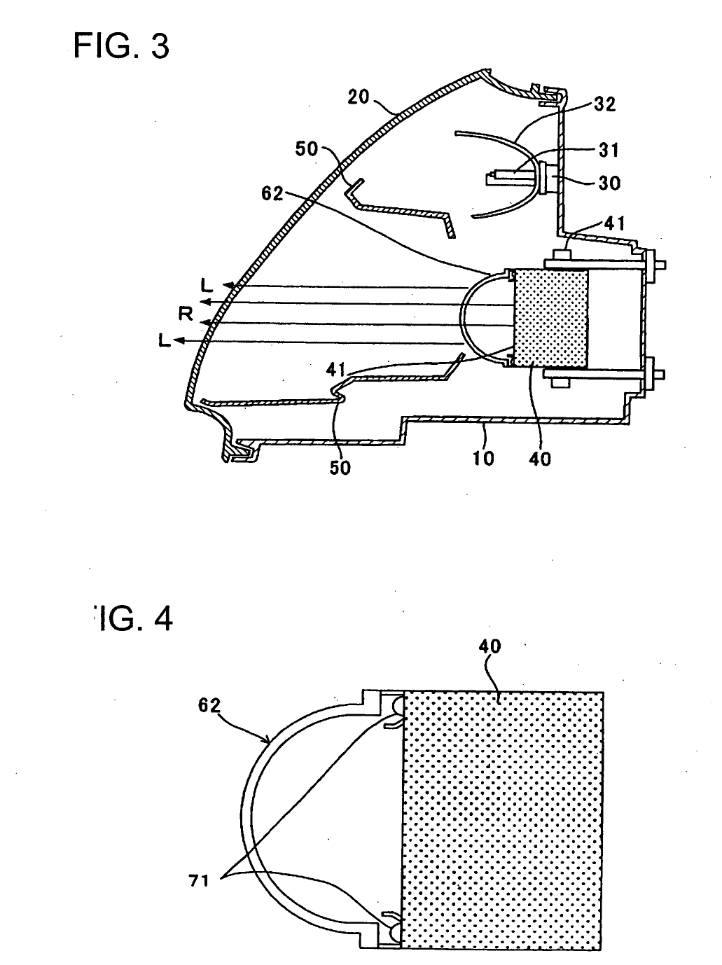

FIG. 3 is a vertical cross-sectional view of the structure of a vehicular lamp according to the third embodiment of the present invention.

Compared with the second embodiment, the third embodiment differs in that a light guide plate 62 in an arc shape (or hemispheric shape) is provided on the front surface of the millimeter wave radar 40. As seen from FIG. 4, dedicated light sources 71 are disposed within the vicinity of a portion that contacts the space formed by the light guide plate 62 and the millimeter wave radar 40 and radiates light to the base end surface of the light guide plate 62. The dedicated light source 71, similar to that of the second embodiment, is structured from a semiconductor light-emitting element such as an LED.

In the vehicular lamp with the structure described above, the light guide plate 62 is illuminated in accordance with the light radiated by the dedicated light sources 71 to the side surface of the light guide plate 62 regardless of whether the light source unit 30 is lit or unlit. Therefore, the millimeter wave radar 40 is not visible from the front of the lamp. Furthermore, because the space in front of the millimeter wave radar 40 is wide open, the millimeter wave signal R is transmitted forward without any significant attenuation.

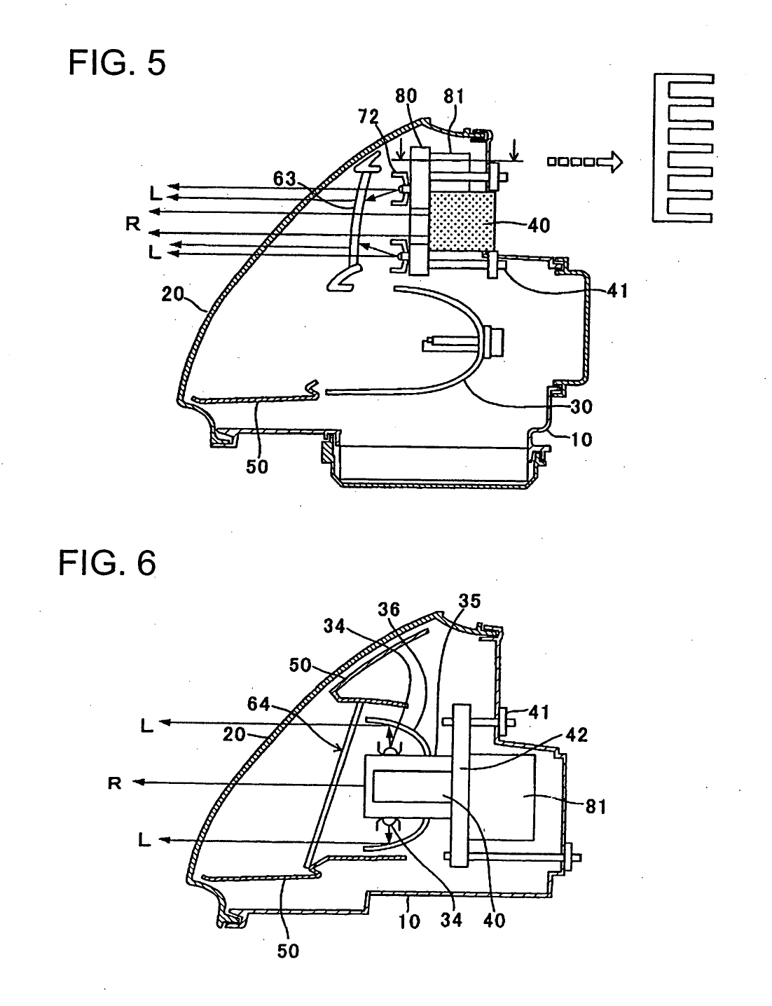

FIG. 5 is a vertical cross-sectional view of the structure of a vehicular lamp according to a fourth embodiment of the present invention.

Compared with the second embodiment, the vehicular lamp of the fourth embodiment differs in that the vertical positions of the millimeter wave radar 40 and the light source unit 30 are switched. In other words, the millimeter wave radar 40 is provided above the light source unit 30. The dedicated light sources 72 for illuminating the light guide plate 63 is disposed on an LED substrate 80 provided on the front surface of the millimeter wave radar 40 such that the radiated light from the dedicated light sources 72 advances toward the front of the lamp. The back surface of the LED substrate 80 is provided with a heat sink 81 for heat releasing. The heat sink 81 has a fin as shown in FIG. 5 and effectively releases the heat from the LED substrate 80 and millimeter wave radar 40.

According to the vehicular lamp with the structure described above, the light guide plate 63 is illuminated by the light radiated from the dedicated light source 72 regardless of whether the light source unit 30 is lit or unlit. Therefore, the millimeter wave radar 40 is not visible from the front of the lamp. The radiated light that is from the dedicated light sources 72 advances forward, and the radiated light that is from the light source unit 30 advances forward toward the opened space in front of the light source unit 30; accordingly, it is possible to secure a light emission area on the lamp front surface. Furthermore, because the space in front of the millimeter wave radar 40 is wide open, the millimeter wave signal R is transmitted forward without any significant attenuation.

FIG. 6 is a vertical cross-sectional view of the structure of a vehicular lamp according to the fifth embodiment of the present invention.

Compared with the second embodiment, the fifth embodiment differs in that the light source unit 30 is replaced with small LED light sources 34, and the LED light sources 34 are integrated with the millimeter wave radar 40. As seen from FIG. 6, the LED light sources 34 are disposed as a light source for forward illumination above and below the millimeter wave radar 40 which is fixed to a bracket 42. The LED light sources 34 are provided and held on an LED substrate 35, and this LED substrate 35 is provided with a reflector 36 such that the radiated light from the LED light sources 34 is effectively reflected toward the front of the lamp. On the back surface of the bracket 42 is provided a heat sink 81 for heat releasing.

According to the vehicular lamp of the structure described above, the radiated light from the LED light sources 34 passes through the light guide plate 64 and advances forward. At such time, the millimeter wave radar 40 is not visible from the front of the lamp because the light guide plate 64 is illuminated. Since the millimeter wave radar 40 and the LED light source 34 are integrated, it is possible to secure a large light emission area on the lamp front surface. Furthermore, because the space in front of the millimeter wave radar 40 is wide open, the millimeter wave signal R is sent forward without any significant attenuation.

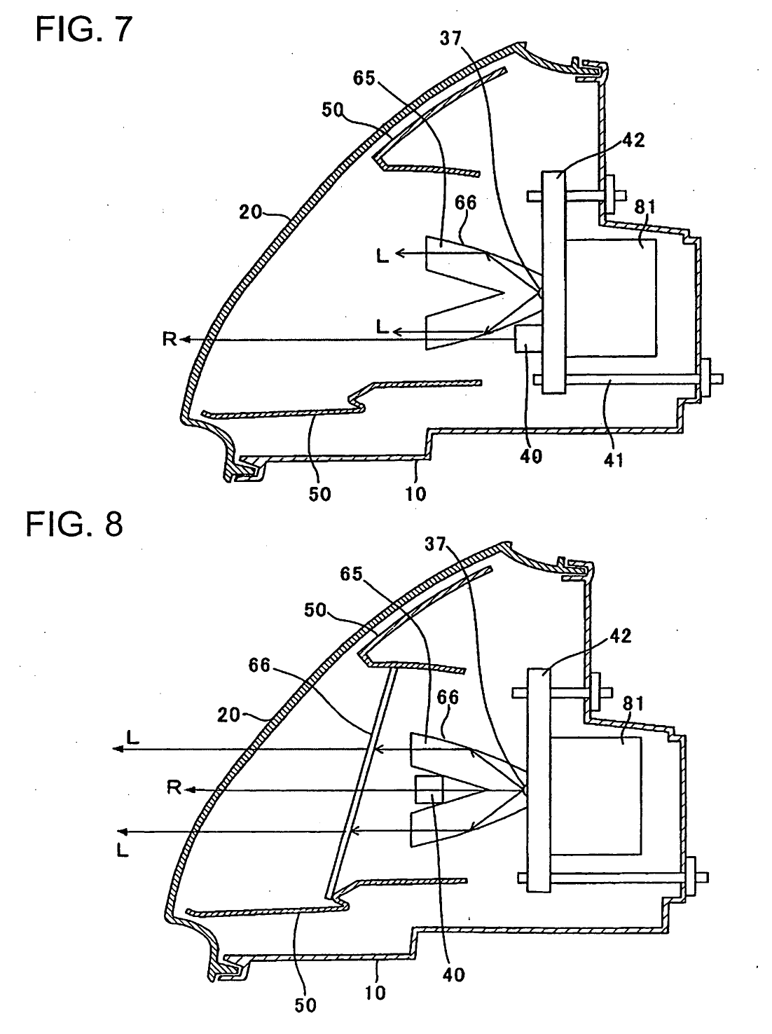

FIG. 7 is a vertical cross-sectional view of the structure of a vehicular lamp according to the sixth embodiment of the present invention.

Compared with the fifth embodiment shown in FIG. 6, the vehicular lamp of the sixth embodiment differs in that a light guide optical member 65, which is formed by a light guide member, is provided, in place of a light guide plate, in front of the LED light source 37 that acts as a main light source of thee lamp for forward illumination. The millimeter wave radar 40 is provided so that it is located on the lower rear portion with respect to the light guide optical member 65. The back surface of the bracket 42 supporting the LED light source 37 is provided with the heat sink 81 for heat releasing.

According to the vehicular lamp shown in FIG. 7, the radiated light from the LED light source 37 passes through the middle portion of the light guide optical member 65, after which the light is completely reflected by the reflecting portion 66 (which is formed as a paraboloid) of the light guide optical member 65 and advances forward. At such time (or when the radiated light from the LED light source 37 passes through the light guide optical member 66), the light guide optical member 65 is illuminated. Accordingly, the millimeter wave radar 40, which is on the rear lower portion with respect to the light guide optical member 65, whose front widens in a tapered shape, is not visible from the front of the lamp. Furthermore, because the space in front of the millimeter wave radar 40 is wide open, the millimeter wave signal R is transmitted forward without any significant attenuation. Furthermore, in the structure shown in FIG. 7, attenuation of the millimeter wave signal R can be minimized because a metallized film is not used in order to reflect the radiated light (or because a reflector that is applied with a metallized film is not used).

FIG. 8 is a vertical cross-sectional view of a structure of a vehicular lamp according to a seventh embodiment of the present invention.

Compared with the sixth embodiment, the seventh embodiment differs in that the millimeter wave radar 40 is disposed forward of the light guide optical member 65, which is formed by a light guide member, and a light guide plate 66, which is formed by a light guide member, is disposed in front of the millimeter wave radar 40.

In the vehicular lamp with this structure, the radiated light from the LED light source 37 passes through the middle portion of the light guide optical member 65, after which the light is completely reflected by the reflecting portion 66, which is formed as a paraboloid, and advances forward. In addition, the radiated light illuminates the light guide plate 66 when it passes through the light guide plate 66. Therefore, the millimeter wave radar 40 behind the light guide plate 66 is not visible from the front of the lamp. Furthermore, because the space in front of the millimeter wave radar 40 is wide open, the millimeter wave R is sent forward without any significant attenuation.

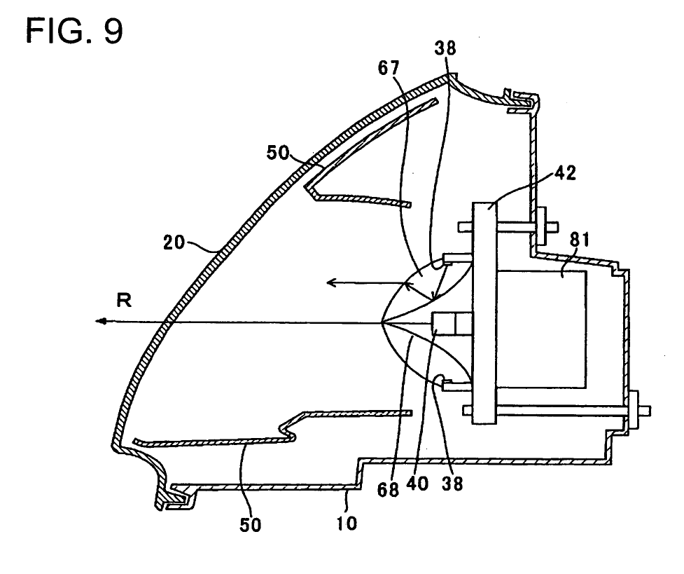

FIG. 9 is a vertical cross-sectional view of the structure of a vehicular lamp according to the eighth embodiment of the present invention.

Compared with the seventh embodiment, the vehicular lamp of the eighth embodiment differs in that the shape of the light guide optical member 67 and the location of the LED light source 38 are changed, and the millimeter wave radar 40 is provided behind the light guide optical member 67. As seen from FIG. 9, the light guide optical member 67 is shaped in a convex lens in cross-section so as to form a space on the bracket 42 side, and the millimeter wave radar 40 is accommodated within the space. In addition, the LED light sources 38 are disposed at the top and bottom of the opening portion of the light guide optical member 67.

According to the vehicular lamp of the eighth embodiment as described above, the radiated light from the LED light sources 38 passes through the light guide optical member 67, after which the light is completely reflected by the reflecting portion 68 and advances forward. At such time, the light guide optical member 67 is illuminated, and thus, the millimeter wave radar 40 provided behind the light guide optical member 67 is not visible from the front of the lamp. Furthermore, because the light guide optical member 67 in front of the millimeter wave radar 40 has a thin thickness part at the center and the space in front of the light guide optical member 67 is wide open, the millimeter wave R is sent forward without any significant attenuation.

1. A vehicular lamp comprising:
a lamp chamber formed by a lamp body and a front cover, and
a main light source provided in said lamp chamber; wherein
a millimeter wave radar is provided inside the lamp chamber, and
a light guide member is provided between the front cover and the millimeter wave radar such that the light guide member is illuminated.

2. The vehicular lamp according to claim 1, wherein the light guide member is illuminated by light radiated from the main light source.

3. The vehicular lamp according to claim 1, wherein the light guide member is illuminated by light radiated from a dedicated light source which is for illuminating the light guide member and provided inside the lamp chamber separated from the main light source.

4. The vehicular lamp according to claim 3, wherein the light guide member is integrally fixed to a front portion of the millimeter wave radar.

5. The vehicular lamp according to claim 1, wherein the main light source uses a semiconductor light-emitting element and is integrally fixed to the millimeter wave radar.

6. The vehicular lamp according to claim 1, wherein the light guide member comprises a middle portion which passes light radiated from the main source and a reflecting portion which completely reflects the light.

7. The vehicular lamp according to claim 1, wherein the light guide member is shaped in a convex lens in cross-section so as to form a space on the backside and the millimeter wave radar is accommodated within the space.
